(19) United States
(12) Patent Application Publication
(10) Pub. No.: US 2007/0194227 A1
(43) Pub. Date: Aug. 23, 2007

(54) METHOD OF CHARACTERIZING AN ION BEAM

(75) Inventor: Robert P. Dolan, Windham, NH (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: IBIS TECHNOLOGY CORPORATION, Danvers, MA (US)

(21) Appl. No.: 11/674,417

(22) Filed: Feb. 13, 2007

Related U.S. Application Data
(60) Provisional application No. 60/773,013, filed on Feb. 13, 2006.

(51) Int. Cl. G21K 7/00

(52) U.S. Cl. 250/309

(57) ABSTRACT

In one aspect, the present invention provides a method for characterizing a (scanned) ion beam pattern. In one embodiment, the method includes providing a semiconductor calibration wafer having a buried ion implanted region with a known profile, exposing the calibration wafer to the (scanned) ion beam to implant a dose of ions therein so as to augment the ion implanted region, measuring a profile of the augmented region, e.g. along a specific diameter aligned with the (scanning) axis of the ion beam pattern under measurement, and characterizing the (scanned) ion beam pattern by comparing the measured profile of the augmented region with the known profile of the calibration region.

### RELATED APPLICATION

The present invention claims priority to a provisional application entitled “Method of Characterizing an ION Beam,” filed on Feb. 13, 2006 and having a Ser. No. 60/773,013. This provisional application is herein incorporated by reference in its entirety.

### BACKGROUND OF THE INVENTION

The present invention relates generally to methods for characterizing an ion beam, and more particularly, to methods for characterizing an ion beam using Fourier-Transform Infrared spectroscopy.

Ion implantation is used routinely in many material-processing applications. For example, in SIMOX (separation-by-implantation-of-oxygen) applications, oxygen ions can be implanted into a semiconductor substrate, e.g., a silicon wafer, to generate a buried insulating layer, e.g., SiO₂, through subsequent annealing steps. In many such applications, it is desirable that the ions be uniformly implanted to ensure obtaining a desired effect. For example, device parameters, such as threshold voltage and leakage current can strongly depend on material characteristics, such as thickness and uniformity of a buried ion implanted region.

In one approach, Fourier-Transform Infrared Reflectance (FTIR) spectroscopy can be used to analyze the uniformity of a buried ion implanted region (e.g., uniformity of implanted ion dosage), which can, in turn, provide information regarding the uniformity of an ion beam implantation pattern (for example scanned ion beam pattern) employed to form that region. However, one drawback associated with such an approach is that it requires implanting a substantial dose of ions that would allow a reliable reflectance measurement. This can, however, be time-consuming and costly.

Accordingly, there is a need for enhanced methods for characterizing an ion beam pattern (or distribution), such as a beam pattern generated by scanning an ion beam over a wafer. There is also a need for such methods that yield accurate beam profiles in a shorter amount of time than traditional approaches.

### SUMMARY OF THE INVENTION

In one aspect, the present invention provides a method for characterizing uniformity of an implanted ion dose pattern that includes providing a semiconductor calibration wafer having a buried ion-implanted region with a known profile (e.g., ion dosage profile) and exposing the calibration wafer to an ion beam to implant a dose of ions therein so as to augment the ion implanted region. The profile of the augmented region can then be measured, and the ion beam pattern, for example a scanned ion beam pattern, can be characterized by comparing the measured profile of the augmented region with the known profile of the calibration region.

In a related aspect, the method includes characterizing an ion beam pattern by subtracting the known profile from the measured profile to obtain a difference profile. The uniformity of the difference profile can then be correlated to the uniformity of the ion beam pattern.

The calibration wafer can be, e.g., a silicon wafer having a buried region that contains implanted oxygen ions which can be utilized to measure, e.g., the profile of a (scanned) oxygen ion beam pattern. The implanted oxygen ions can form islands of silicon oxide in the buried region.

In a related aspect, the profile of an ion beam (e.g. a scanned oxygen beam) can be measured by exposing the calibration wafer to the ion beam so as to implant a dose of oxygen ions in a range of about 1E16 cm⁻² to 4E16 cm⁻² in the wafer. By way of example, the implantation of a dose of ions in the calibration wafer can be achieved by adjusting the energy of the beam to be in a range of about 120 keV to about 220 keV and exposing the wafer to the beam for a duration in a range of about 5 minutes to about 15 minutes.

In another aspect of the invention, a calibration wafer for use in measuring the profile of a (scanned) ion beam can be formed by implanting a dose of that ion in a semiconductor wafer so as to form a buried ion implanted region. The profile of the ion implanted region (e.g., the dose profile of the implanted ion) can then be determined so as to allow its use as a calibration wafer. For example, the calibration wafer can be formed by implanting oxygen ions in a region below a surface of a silicon wafer, and determining the profile of the region.

In a related aspect, the energy of ions in a beam under measurement can be selected to be substantially the same as the energy of ions previously utilized to form the ion implanted region of the calibration wafer.

In another aspect of the invention, an ion beam under study is scanned over the calibration wafer along a direction that is substantially orthogonal (e.g., forms a 90-degree angle) relative to the scan direction of an ion beam previously employed to form the ion implanted region of the calibration wafer, so as to augment ion dosage in that region. In some cases, the ion dose profile of the augmented region is measured by scanning a probe beam (e.g., the probe beam of an FTIR spectrometer) across the wafer in the same direction as the ion beam scan direction.

In yet another aspect of the invention, a system for characterizing a (scanned) ion beam pattern is provided. The system can include a calibration wafer having a buried ion implanted region with a known profile (e.g., a known ion dose profile), and a spectrometer adapted to measure the profile of an augmented region formed by exposing the wafer to an ion beam so as to implant ions in the calibration region (or in vicinity thereof). The system can further include a data processor adapted to characterize an ion beam by comparing the known profile of the calibration region with a measured profile of the augmented region.

Further understanding of the invention can be obtained by reference to the following detailed description and the associated drawings, which are described briefly below.

### BRIEF DESCRIPTION OF THE DRAWINGS

FIG. 1 is a flow chart depicting various steps in one embodiment of a method of the invention for measuring the uniformity of an ion beam,

FIG. 2A schematically illustrates a semiconductor calibration wafer having a buried ion implanted region with a known profile,

FIG. 2B schematically illustrates the calibration wafer of FIG. 2A having an augmented ion implanted region,

FIG. 3 schematically illustrates an ion implantation system,

FIG. 4 schematically illustrates measuring the profile of an augmented ion implanted region by utilizing FTIR spectroscopy,

FIG. 5 schematically illustrates a system according to one embodiment of the invention for measuring the uniformity of a (scanned) ion beam pattern,

FIG. 6 is an exemplary dosimetry map,

FIG. 7A illustrates ion dosage as a function of points across a wafer obtained by employing a conventional method of measuring the uniformity of a (scanned) ion beam pattern,

FIG. 7B illustrates ion dosage as a function of points across a wafer obtained by employing an embodiment of a method of the invention,

FIG. 8A illustrates ion dosage as a function of points across a wafer obtained by employing a conventional method of measuring the uniformity of a (scanned) ion beam pattern,

FIG. 8B illustrates ion dosage as a function of points across a wafer obtained by employing an embodiment of a method of the invention,

FIG. 9A illustrates ion dosage as a function of points across a wafer for an exemplary calibration wafer,

FIG. 9B illustrates ion dosage as a function of points across the calibration wafer of FIG. 9A after it is exposed to an ion beam under measurement, and

FIG. 9C illustrates the difference between the profile shown in FIG. 9B and the profile shown in FIG. 9A.

### DETAILED DESCRIPTION

The present invention generally provides an improved method for characterizing a (scanned) ion beam pattern by employing a “calibration standard,” such as a calibration wafer having a buried ion implanted region—formed, e.g., by ion implantation—whose profile (e.g., ion dose profile) is known.

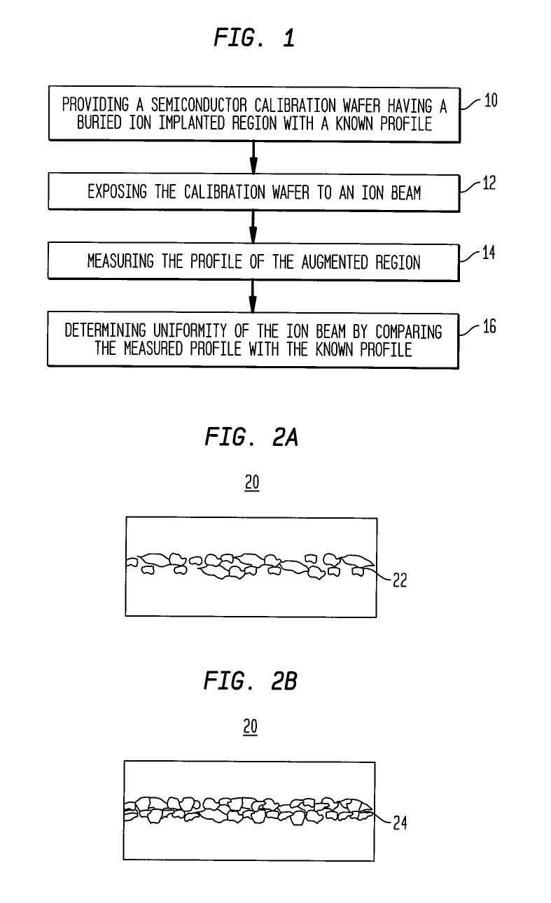

With reference to a flow chart shown in FIG. 1, in one exemplary embodiment, in step 10, a semiconductor calibration wafer having a buried ion implanted region with a known profile is provided. In step 12, the calibration wafer is exposed to an ion beam to implant a dose of ions therein so as to augment the ion implanted region. In step 14, the profile of the augmented region is measured, and in step 16 uniformity of a (scanned) ion beam pattern is determined by comparing the measured profile of the augmented region with the known profile of the calibration region (the ion implanted region originally present in the calibration wafer).

FIG. 2A shows an exemplary embodiment of a calibration wafer 20 having a buried ion implanted region 22 with a known profile (e.g., a known ion dose or density profile). A variety of techniques (such as ion implantation or plasma immersion) can be employed to prepare the calibration wafer. By way of example, in some embodiments, oxygen ions can be implanted in a silicon wafer to form an ion implanted buried region (also referred to as a damaged region). In some embodiments, the implanted ions in the region form discontinuous islands of insulating material (such as silicon oxide islands). The profile (e.g., ion dose profile) of the buried region is then determined by utilizing techniques known in the art, such as FTIR spectroscopy. Such a calibration wafer can then be employed to measure the profile of a (scanned) ion beam profile, such as an oxygen ion beam.

Although in many embodiments described herein, the calibration wafer includes a silicon wafer having an oxygen ion implanted buried region with a known profile, which can be utilized for measuring the profile of a (scanned) oxygen beam, a calibration wafer can also be formed by using other semiconductor substrates and other implanted ions.

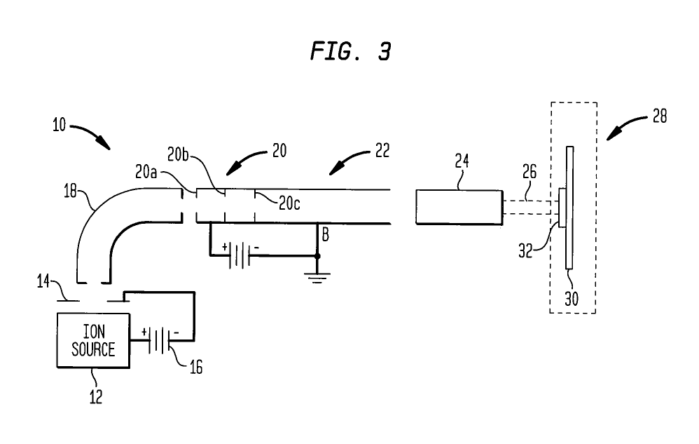

A calibration wafer according to the teachings of the invention can be utilized in a variety of ion implantation systems for measuring the profile of a (scanned) ion beam. By way of example, FIG. 3 schematically depicts an exemplary embodiment of such an ion implantation system 10 that includes an ion source 12, maintained at a high electric potential for generating ions of a selected species, e.g., oxygen. Generally, the ion source can be maintained at a voltage of about 10 kV to about 250 kV relative to ground (about 10 kV to about 100 kV relative to source terminal). The ion implantation system 10 further includes an extraction electrode 14 for drawing the ions from the ion source 12. The extraction electrode 14 is maintained at a selected voltage differential relative to the ion source by utilizing, for example, a voltage source 16. The extraction electrode 14 can be held at a negative or positive potential relative to the ion source depending on the sign of the charged ions, i.e., positive or negative, to be extracted.

The exemplary implantation system 10 further includes an analyzer 18, for example, a magnetic analyzer, which selects appropriately charged and energized ions. An ion accelerator 20 formed, for example, of a plurality of electrodes 20a, 20b, and 20c, each of which is maintained at a selected electric potential, accelerates ions to a desired final energy, for example, in a range of about 10 keV to about 220 keV.

Upon leaving the accelerator 20, the ion beam enters a transit region 22, maintained at ground electric potential, that extends to a beam forming device 24. The beam forming device 24 shapes the accelerated ions into an ion beam pattern 26 having selected cross-sectional shape and area.

The implantation system 10 further includes an end station 28 having a wafer holder 30 on which a substrate 32, e.g., a semiconductor wafer, can be disposed to face the ion beam pattern 26. The calibration wafer can be mounted to the wafer holder to be exposed to an ion beam pattern for which a profile measurement is desired. After implanting a dose of ions in the calibration wafer (e.g., a dose in a range of about 1E16 cm⁻² to about 4E16 cm⁻²), the calibration wafer can be removed from the implantation system and transferred to an instrument (e.g., an FTIR spectrometer) that is capable of measuring the profile of the augmented buried ion implanted region.

To minimize non-uniformity, in some embodiments the ion beam can scan the calibration wafer in a direction that is substantially orthogonal to the ion beam scan direction previously utilized to form the ion implanted region of the calibration wafer. As shown in FIG. 2B, in many embodiments, the exposure of the calibration wafer to the ion beam causes implantation of a plurality of ions within the existing (calibration) buried ion implanted region. It is desirable that the ions of the beam under measurement be implanted into the existing buried ion implanted region so that the augmented region would reflect the sum of the ion dosage in the pre-existing calibration region and the dosage implanted as a result of exposure of the calibration wafer to the ion beam under study. To achieve this result, in many embodiments, the energy of ions in the beam under measurement is selected to be substantially the same as the energy of ions previously utilized to form the calibration ion implanted region. For example, both the ion beam to be measured and the ion beam used to generate the calibration wafer can provide ions having an energy in a range of about 120 keV to about 220 keV.

In some cases, the implanted ions in the augmented region 24 form islands of insulating material, although in other cases they can form a continuous layer or have interstitial ions.

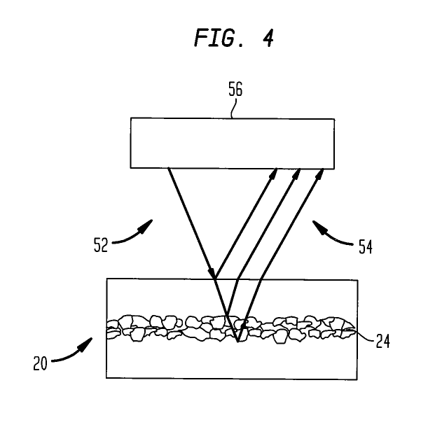

As noted above, once the calibration wafer is implanted with a small dose of ions, the profile (e.g., ion dosage profile) of the augmented ion implanted region can be measured. Various techniques can be used to measure the profile of that region. In one technique, known in the art as FTIR, the profile can be measured by Fourier transform reflectance spectroscopy. As shown schematically in FIG. 4, in FTIR spectroscopy, beams of light 52, generated by a radiation source (not shown) of a spectrometer 56, are directed toward the surface of a wafer under study at a selected angle and intensity such that some photons from the beams of light are absorbed by the wafer and some photons 54 are reflected at different depths within the wafer for detection. The beam is scanned across the wafer, and the reflected data is collected. In one embodiment, the dosage profile of the augmented ion implanted region can be measured in the same direction as the scan direction of the ion beam under measurement. The reflected data collected by the spectrometer 56 can be employed in a manner known in the art to derive the profile of the augmented region. For example, the reflected data can be compared to known characteristics and models for a given wafer configuration thereby yielding an ion dosage profile (or density profile) for the ion implanted region. For example, the intensity and phase data for a particular wavelength of light can be compared to known characteristics and models for a given semiconductor material (e.g., a specific semiconductor material processed in a particular manner) or a specific interface known to form between two regions of the same semiconductor material after particular semiconductor processing techniques have been utilized, to derive the profile of the augmented region. Further details concerning FTIR spectroscopy can be found in U.S. Pat. No. 6,605,482, the teachings of which are hereby incorporated by reference.

Once the profile of the augmented ion implanted region is determined, it can be compared to the known profile of the calibration region to characterize the (scanned) ion beam pattern. More specifically, the comparison includes subtracting the known profile from the measured profile to obtain a difference profile. The difference profile can then be correlated to the uniformity of the (scanned) ion beam pattern. For example, the profile can be used to generate a dosimetry map, which provides information regarding the degree of uniformity of the ion beam pattern profile. By way of example, FIG. 6 illustrates a sample dosimetry map that identifies the formation of regions with excessive ion dosage thereby highlighting non-uniform regions of the (scanned) ion beam.

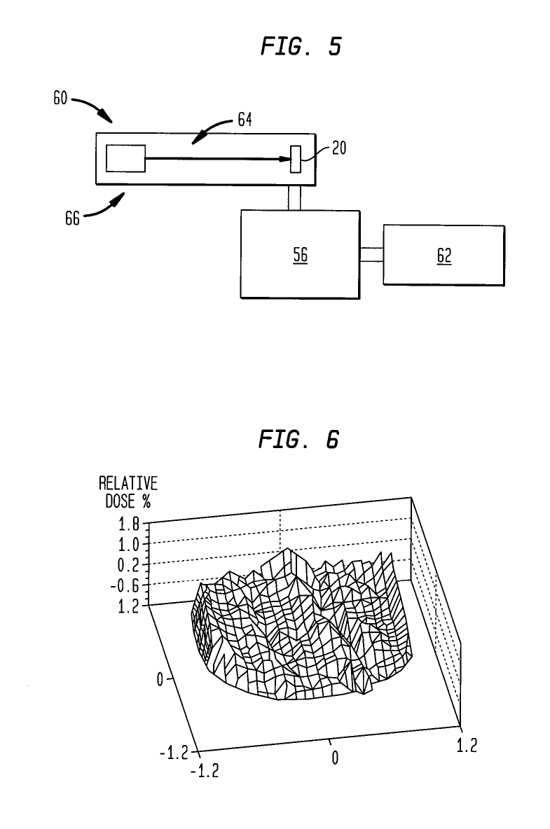

With reference to FIG. 5, in one embodiment, the data from the spectrometer 56 can be input into a data processor 62 for analysis, e.g., generating a dosage profile. In this embodiment, the data processor 62 can be part of a system 60 including a calibration wafer 20, a spectrometer 56, and an ion implantation system 66 that cooperatively allow determining the cross-sectional uniformity of an ion beam 64.

The methods of the invention provide a number of advantages. For example, they allow measuring the profile of an ion beam in a shorter time period and with a lower ion implantation dose than conventional techniques. By way of example, one advantage of methods of the invention is that when the ion dose required to provide a meaningful measurement of an ion beam pattern is high, only the calibration wafer is required to have an implanted ion dose at this high level, with the augmentation dose 10× to 100× lower while still producing a combined (calibration plus augmentation) dose that lies in the accurate range of a measurement device, for example, FTIR spectrometer. For example, the use of a calibration wafer having a pre-existing buried ion implanted region with a known profile allows measuring the profile of a beam by implanting an ion dose in a range of 1E16 cm⁻² to about 4E16 cm⁻², or in a range of about 1E16 cm⁻² to about 2E16 cm⁻². Such implantation dosages can be readily achieved by exposing the wafer to a beam having an energy in a range of about 120 keV to about 220 keV over a time period in a range of about 5 minutes to about 15 minutes.

Moreover, in many embodiments the measurement of a (scanned) ion beam pattern can be utilized to make corrections to the devices that produced that pattern so as to enhance the uniformity of an ion dose pattern implanted in a wafer. For example, the scanning speed of a beam across the wafer can be adjusted in response to the ion beam pattern measurements to enhance the uniformity of the pattern.

By way of further description of various aspects of the invention and only for illustrative purposes, the following examples are provided. It should be clear, however, that various changes, additions and subtractions can be made by those skilled in the art without departing from the spirit or scope of the invention. For example, although the examples are described in the context of creating an oxygen ion implanted region in a silicon substrate, the teachings of the invention can also be applied to other semiconductor substrates and other implanted ions. Further, the examples are not intended to necessarily provide the optimal resolution that can be obtained by methods of the invention.

### EXAMPLE 1

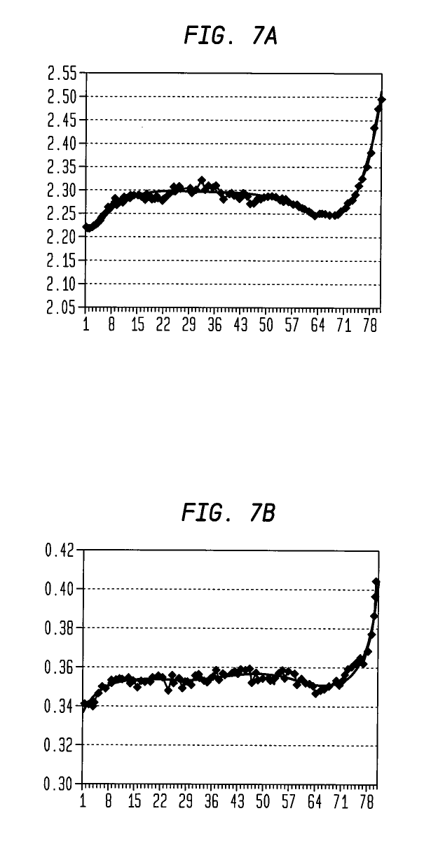

This example illustrates a six times reduction in dose required to characterize the uniformity of a (scanned) ion beam pattern relative to conventional techniques. Using the traditional method of forming an oxygen ion implanted region within a silicon wafer at a high ion dosage, a dose of 2.4E17 cm⁻² oxygen ions was implanted in a silicon wafer by exposing the wafer to the ion beam to be measured for a duration of 132 minutes. FTIR was then used to generate the dose profile of the ions implanted in the wafer, as shown in FIG. 7A. The dose profile indicated a 17% uniformity across the wafer for the implanted ions.

Using a method according to one embodiment of the invention, a dose of 4E16 cm⁻² oxygen ions was implanted in a calibration wafer (having a buried ion implanted region with a known profile) by exposing the wafer to the same ion beam as that employed in the above traditional method for a duration of only 22 minutes. FTIR was then used to determine the profile of the augmented region. The known profile of the calibration wafer was then subtracted from the measured profile to obtain a difference profile, shown in FIG. 7B. The difference profile indicated a uniformity of 17% for the ion dosage, which is consistent with the value obtained by utilizing the traditional method but with much less ion dosage.

### EXAMPLE 2

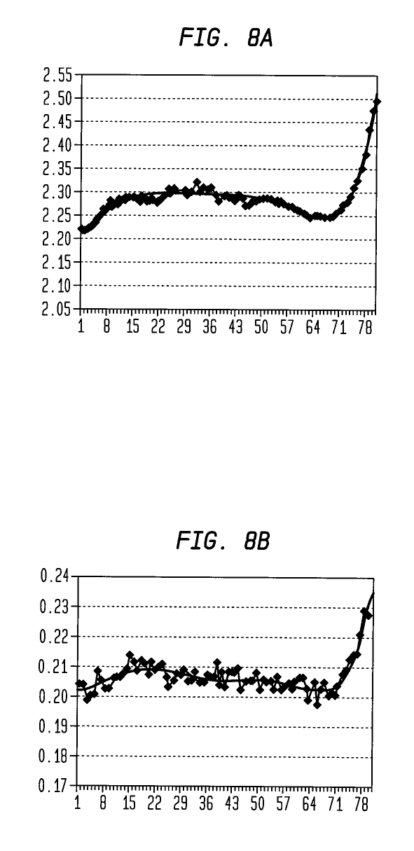

This example illustrates a ten times reduction in dose required to characterize the uniformity of a (scanned) ion beam pattern. Using the above traditional method, a dose of 2.4E17 cm⁻² oxygen ions was implanted in a wafer by exposing the wafer to an ion beam under measurement for a duration of 132 minutes. FTIR was then used to generate the profile of the implanted ions in the wafer, as shown in FIG. 8A, which yielded a 17% uniformity.

Using a method according to one embodiment of the claimed invention, a dose of 2.4E16 cm⁻² oxygen ions was implanted in a calibration wafer (having a buried ion implanted region with a known profile) by exposing the wafer to the same ion beam as the one used in the above traditional method, for a duration of 13 minutes. The known profile of the calibration wafer was then subtracted from the measured profile to obtain a difference profile (shown in FIG. 8B). The difference profile was used to determine a uniformity of 16.2% for the (scanned) ion beam pattern.

### EXAMPLE 3

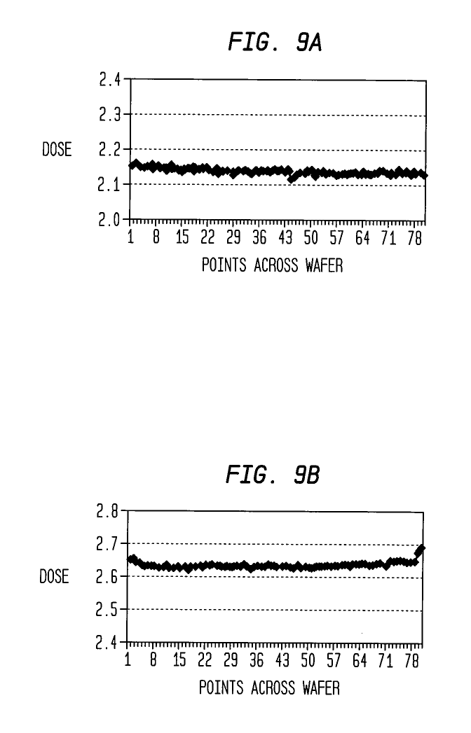

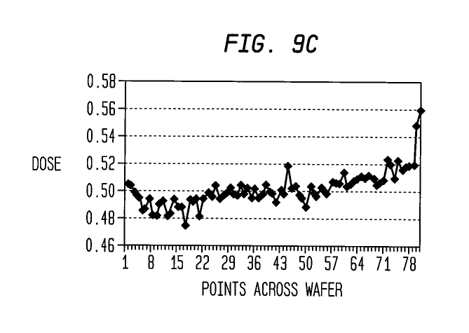

Using a method according to one embodiment of the claimed invention, a dose of about 2.15E17 cm⁻² oxygen ions was implanted in a wafer by scanning the wafer with an ion beam to form a calibration wafer. FIG. 9A shows the profile of the calibration ion implanted region, which was measured using FTIR. The calibration wafer was then scanned by an ion beam under measurement in a direction substantially orthogonal (e.g., forms a 90-degree angle) relative to the scan direction of the beam utilized to form the ion implanted region in the calibration wafer. The ions implanted in the calibration wafer augment the pre-existing ion implanted region. FIG. 9B shows the profile of the augmented region measured by using FTIR. The profile of the calibration region (FIG. 9A) was then subtracted from the measured profile of the augmented region (FIG. 9B) to obtain a difference profile shown in FIG. 9C.

Those having ordinary skill in the art will appreciate that various modifications can be made to the above exemplary embodiments without departing from the scope of the invention.

What is claimed is:

1. A method for characterizing an ion beam pattern, comprising:
providing a semiconductor calibration wafer having a buried ion implanted region with a known profile;
exposing the calibration wafer to the ion beam to implant a dose of ions therein so as to augment the buried region;
measuring a profile of the augmented region; and
characterizing the ion beam pattern by comparing the measured profile of the augmented region with said known profile of said region.

2. The method of claim 1, wherein the step of characterizing the ion beam pattern comprises subtracting said known profile from said measured profile to obtain a difference profile.

3. The method of claim 1, further comprising correlating a uniformity of said difference profile to the uniformity of the ion beam.

4. The method of claim 1, wherein said profiles represent ion dosage profiles.

5. The method of claim 1, wherein said calibration wafer comprises a silicon wafer having a buried oxygen ion implanted region.

6. The method of claim 5, wherein said ion beam comprises a beam of oxygen ions.

7. The method of claim 6, wherein the step of exposing the wafer to the ion beam comprises implanting a dose of oxygen ions in a range of about 1E16 cm⁻² to 4E16 cm⁻² in the wafer.

8. The method of claim 6, wherein the step of exposing the wafer to the ion beam comprises implanting a dose of oxygen ions in a range of about 1E16 cm⁻² to 2E16 cm⁻² in the wafer.

9. The method of claim 1, wherein said ion implanted region comprises a plurality of insulating portions formed by reaction of said implanted ions with said semi-conducting material of the wafer.

10. The method of claim 1, wherein the ion beam provides ions having an energy in a range of about 120 keV to about 220 keV.

11. The method of claim 10, further comprising exposing the calibration wafer to the ion beam for a duration in a range of about 5 minutes to about 15 minutes.

12. The method of claim 1, wherein the step of providing said calibration wafer further comprises:
implanting a semiconductor wafer with a dose of said ions so as to form said buried ion implanted region, and
measuring a profile of said region.

13. The method of claim 12, wherein an energy of ions in the beam for generating said calibration wafer is substantially the same as an energy of ions in the beam whose profile uniformity is measured.

14. The method of claim 12, wherein the step of implanting the wafer to form a calibration wafer further comprises scanning the wafer with a beam of said ions.

15. The method of claim 14, wherein implanting the calibration wafer with a dose of ions comprises scanning the calibration wafer in a direction substantially orthogonal to the scan direction of the beam utilized to form the calibration wafer.

16. The method of claim 15, wherein measuring the profile of the augmented region comprises measuring the implanted ion dosage in a direction substantially the same as the scan direction of the beam whose profile is measured.

17. The method of claim 1, further comprising utilizing FTIR to measure the profile of the augmented region.

18. A system for characterizing an ion beam, comprising:
a calibration wafer having a buried ion implanted region with a known profile;
a spectrometer adapted to measure a profile of an augmented region formed by exposing the calibration wafer to an ion beam to implant ions in said region; and
a data processor adapted to characterize the beam by comparing the known profile of the calibration region with said measured profile of the augmented region.

19. The system of claim 18, wherein said profiles comprise ion dosage profiles.

20. A calibration wafer for use in measuring a profile of an ion beam, comprising:
a silicon substrate;
an oxygen ion implanted buried region formed in said substrate;
wherein a profile of said region is known.

21. A method for measuring uniformity of an ion beam, comprising:
providing a silicon calibration wafer having an oxygen ion implanted buried region;
implanting a dose of oxygen ions in said region by exposing the wafer to the oxygen ion beam;
subsequently measuring a profile of said region; and
determining uniformity of said beam by comparison of the pre-implantation and post-implantation profiles of said buried region.

22. The method of claim 21, wherein said buried region comprises a plurality of silicon oxide islands.
